(19) United States
(12) Patent Application Publication
(10) Pub. No.: US 2021/0123389 A1
(43) Pub. Date: Apr. 29, 2021

(54) DUAL-CRANKSHAFT, OPPOSED-PISTON ENGINE WITH MECHANICALLY UNCOUPLED CRANKSHAFTS

(71) Applicant: ACHATES POWER, INC., San Diego, CA (US)

(72) Inventor: ASHWIN A. SALVI, San Diego, CA (US)

(73) Assignee: ACHATES POWER, INC., San Diego, CA (US)

(21) Appl. No.: 16/661,334

(22) Filed: Oct. 23, 2019

(51) Int. Cl. F02D 41/00; F02B 75/28; F02B 75/02; F02D 15/02; F02B 63/04; F01B 7/02

(52) U.S. Cl. CPC F02D 41/009; F02B 75/28; F02B 75/02; F02D 2200/04; F02B 63/04; F01B 7/02; F02B 2075/025; F02D 15/02

(57) ABSTRACT

An opposed-piston engine with two crankshafts includes a first power transducer coupled to a first crankshaft of the two crankshafts and a second power transducer coupled to a second crankshaft of the two crankshafts. The two crankshafts are not rotatably connected, and so are free to rotate independently of each other. Phase relationships between the crankshafts may be controlled by operating the power transducers to increase, or reduce, crankshaft torque. Changes in crankshaft phase relationships cause changes in opposed piston locations, which, in turn, enable control of engine performance factors.

### FIELD OF THE INVENTION

The invention relates to opposed-piston engines with two crankshafts which rotate independently of each other.

### BACKGROUND OF THE INVENTION

An opposed-piston engine has at least one cylinder which contains two pistons disposed for back-and-forth movement in opposite directions of the cylinder. Each piston is linked by a connecting rod to a respective one of two separate crankshafts, and each crankshaft is positioned at a respective end of the cylinder. This configuration is referred to as a dual-crankshaft, opposed-piston engine. The crankshafts are mounted separately to an engine block but are coupled (linked together, rotatably connected) by mechanical means external to the engine block that synchronize their rotations and deliver engine power to a power takeoff shaft. These mechanical means typically include elements such as gears, transfer shafts, belts, or chains.

Due to the dynamics of dual-crankshaft, opposed-piston engine operation and any out-of-phase motions of the opposing pistons, the crankshafts frequently experience torque pulsations caused by large forces and load reversals occurring in the operating range of the engine. This subjects any mechanical device coupling the crankshafts subject to high peak forces and load reversals. The mechanical coupling device also experiences thermal effects as well as production manufacturing tolerances which affect clearances (gear backlash) and tensions (belt or chain) within the device. As a result, such mechanical coupling devices produce considerable noise, vibration, and harshness. Consequently, they are built to meet design specifications which cause them to be heavy, costly, and high in friction.

### SUMMARY OF THE INVENTION

An objective of the invention is to control rotation of the separate crankshafts of a dual-crankshaft, opposed-piston engine, without a mechanical device that rotatably connects the crankshafts.

A further objective of the invention is to synchronize rotation of two independently-rotating crankshafts of an opposed-piston engine while providing power from the engine.

The invention makes it possible to control the crankshaft rotations of a dual-crankshaft, opposed-piston engine without a mechanical device that rotatably connects the two crankshafts of the engine. According to the invention, a first power transducer device is operatively coupled to a first crankshaft of the two crankshafts and a second power transducer device is operatively coupled to a second crankshaft of the two crankshafts. A control mechanization is configured to operate the power transducer devices in such a manner as to provide angular position feedback to the crankshafts with which to control their rotations.

According to a preferred embodiment of the invention, a dual-crankshaft, opposed-piston engine is provided, without a mechanical device that rotatably connects the two crankshafts of the engine. Instead, the two crankshafts are adapted to rotate independently. Each crankshaft of the two crankshafts is directly coupled to a respective one of two electrical motor/generator devices. Each electrical motor/generator device is configured to convert mechanical torque of a respective crankshaft to electrical power or to convert electrical power to mechanical torque for the respective crankshaft. A method is provided to control rotation of each crankshaft by provision of angular position feedback separately to a first crankshaft of the two crankshafts via a first electrical motor/generator device of the two electrical motor/generator devices and to a second crankshaft of the two crankshafts via a second electrical motor/generator device of the two electrical motor/generator devices.

The invention may be adapted to realize other benefits. The method to control rotation of each crankshaft by provision of angular position feedback separately to the first and second crankshafts may include procedures to control locations of opposing pistons in a cylinder of the engine during operation of the engine in order to vary a target metric of the engine such as compression ratio, scavenging, or combustion.

Thus, in a particular aspect of the invention as practiced in an opposed-piston engine with two independently-rotating crankshafts, as two pistons move coaxially in a cylinder of the engine, toward and away from each other during a cycle of engine operation, respective locations of the pistons may be varied through provision of angular position feedback separately to a first crankshaft of the two crankshafts which is operatively coupled to a first piston of the two pistons and/or to a second crankshaft of the two crankshafts which is operatively coupled to a second piston of the two pistons. Variation of the piston locations through feedback control of crankshaft rotation may be beneficially applied to enable control of performance factors of the engine. The controlled performance factor may comprise one of a compression ratio or a scavenging rate.

### BRIEF DESCRIPTION OF THE DRAWINGS

FIG. 1 shows an exemplary dual-crankshaft, opposed-piston, internal combustion engine of the prior art.

FIG. 2 shows a side view of a geartrain of the prior art as may be configured to mechanically couple the two crankshafts of the opposed-piston engine of FIG. 1.

FIG. 3 shows a dual-crankshaft, opposed-piston engine device according to the invention.

FIG. 4 shows a dual-crankshaft, opposed-piston engine device according to the invention configured for use in a hybrid drive system.

FIG. 5 shows certain elements of the dual-crankshaft, opposed-piston engine device of FIG. 3 in greater detail, in order to illustrate representative parameters that may be used in control routines according to the invention.

FIG. 6A shows piston locations for a first compression ratio; FIG. 6B shows piston locations for a second compression ratio, less than the first compression ratio.

FIG. 7A shows piston locations for a first scavenging rate; FIG. 7B shows piston locations for a second scavenging rate.

### DETAILED DESCRIPTION OF EMBODIMENTS OF THE INVENTION

An opposed-piston engine is an internal-combustion engine characterized by an arrangement of two pistons disposed in the bore of a single cylinder for reciprocating movement in opposing directions along the longitudinal axis of the cylinder's bore. An opposed-piston, internal combustion engine differs in many respects from a conventional internal combustion engine, which has a single piston in each cylinder. In an opposed-piston engine, a combustion chamber is formed in a cylinder, between the end surfaces of two opposed pistons moving in the cylinder; in a conventional engine, the combustion chamber is formed between a cylinder head and the end surface of the single piston moving in the cylinder. In an opposed-piston engine, air enters the cylinder through an intake port in the cylinder, near one of its two ends, and exhaust exits the cylinder through an exhaust port located in the cylinder near the other of its two ends. The intake port is opened and closed by one of the two pistons and the exhaust port is opened and closed by the other of the two pistons. Contrastingly, in other internal combustion engines air and exhaust enter and exit the cylinder via intake and exhaust ports which are opened and closed by valves.

Typically, an opposed-piston engine completes a cycle of operation with a single complete rotation of a crankshaft and two strokes of a piston connected to the crankshaft. The strokes are denoted as compression and power strokes. Each piston moves between a respective bottom center (BC) region in the cylinder where it is nearest one end of the cylinder, and a respective top center (TC) region within the cylinder where it is furthest from the one end. The cylinder has ports near the respective BC regions. Each of the opposed pistons controls a respective one of the ports, opening the port as it moves to its BC region, and closing the port as it moves from BC toward its TC region. One port serves to admit charge air into the bore, the other port provides passage for the products of combustion out of the bore; these are respectively termed “intake” and “exhaust” ports (in some descriptions, intake ports are referred to as “air” ports or “scavenge” ports). Charge air enters a cylinder through the intake port near one end of the cylinder, and exhaust gas flows out of the exhaust port near the cylinder's opposite end; thus gas flows through the cylinder in a single direction (“uniflow”)—from intake port to exhaust port—and the displacement of exhaust gas by charge air is referred to as “uniflow scavenging”.

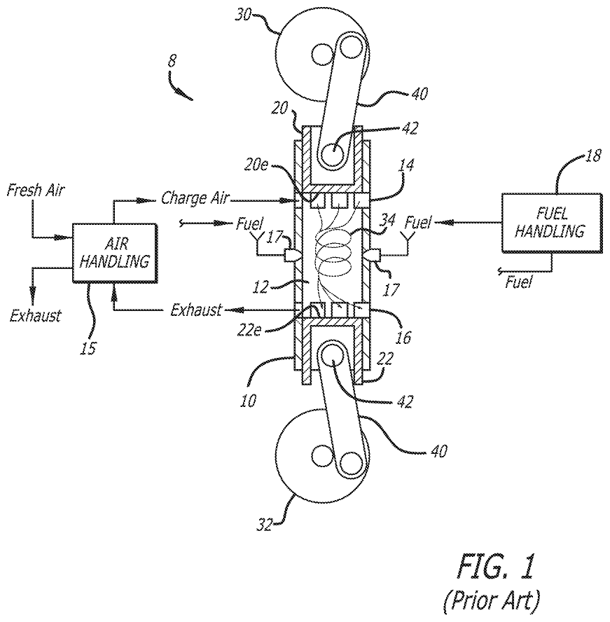

FIG. 1 is a schematic representation of an exemplary dual-crankshaft, opposed-piston engine, and is propely labeled “Prior Art”. Preferably, the engine is a two-stroke cycle, uniflow-scavenged, opposed-piston engine (hereinafter, “the opposed-piston engine”) that includes at least one cylinder. The opposed-piston engine 8 is preferably operated on the compression-ignition principle, but it may operate with electronic or optical ignition assistance. The opposed-piston engine 8 may have one cylinder, or it may comprise two cylinders, or three or more cylinders. In any event, the cylinder 10 represents both single cylinder and multi-cylinder configurations of the opposed-piston engine 8. The cylinder 10 includes a bore 12 and longitudinally spaced-apart intake and exhaust ports 14 and 16, which are machined, molded, or otherwise formed in the cylinder, near respective ends thereof. An air handling system 15 of the opposed-piston engine 8 manages the transport of charge air into, and exhaust out of, the engine by way of these ports. Each of the intake and exhaust ports includes one or more openings communicating between the cylinder bore and an associated manifold or plenum. In many cases a port comprises one or more circumferential arrays of openings in which adjacent openings are separated by a solid portion of the cylinder wall (also called a “bridge” or a “bar”). In some descriptions, each opening may be referred to as a “port”; however, the construction of a circumferential array of such “ports” is no different than the port constructions illustrated in FIG. 1. Fuel injectors 17 include nozzles that are secured in holes that open into the cylinder. A fuel system 18 of the opposed-piston engine 8 provides fuel for direct side injection by the injectors 17 into the cylinder. Two pistons 20, 22 are disposed in the bore 12 with their end surfaces 20e, 22e in opposition to each other. For convenience, the piston 20 is referred to as the “intake” piston because it opens and closes the intake port 14. Similarly, the piston 22 is referred to as the “exhaust” piston because it opens and closes the exhaust port 16. Preferably, but not necessarily, the intake piston 20 and all other intake pistons are coupled to a crankshaft 30 of the opposed-piston engine 8; and, the exhaust piston 22 and all other exhaust pistons are coupled to a crankshaft 32 of the engine 8. The crankshaft 30 is referred to as the “intake” crankshaft because of being connected to the intake piston 20 and the crankshaft 32 is referred to as the “exhaust” crankshaft because of being connected to the exhaust piston 22. Piston-to-crankshaft couplings for intake and exhaust pistons include a connecting rod 40 and a wristpin 42.

Following combustion, the opposed pistons 20 and 22 move away from their innermost locations in the cylinder 10. While moving toward their BC locations, the pistons 20 and 22 keep their associated ports closed until they pass the innermost edges of the ports, at which times the ports begin to open. As charge air 34 flows into the cylinder 10 through the intake port 14, the shapes of the intake port openings and surface features of the opposed piston end surfaces induce turbulence in the charge air which promotes air/fuel mixing, effective combustion, and reduction of pollutants.

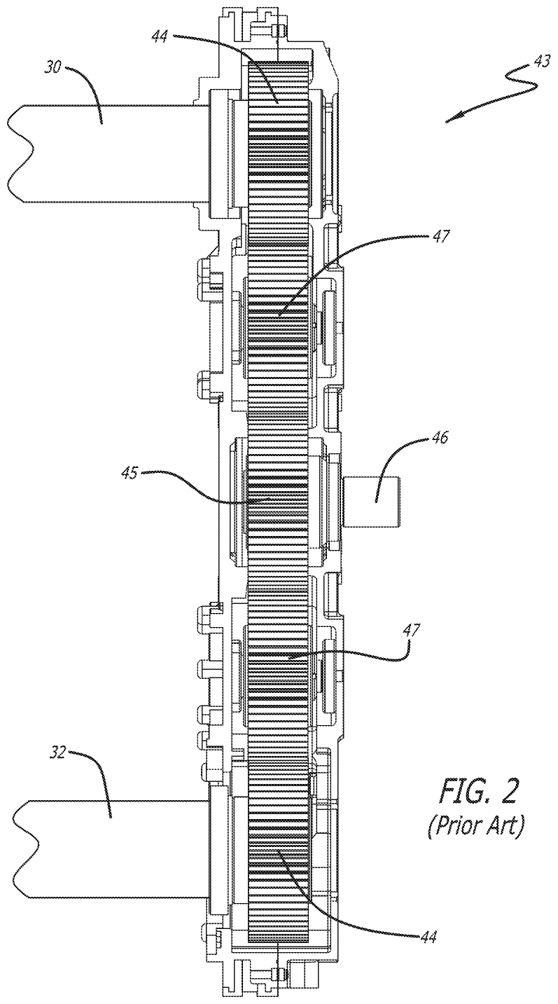

FIG. 2 shows a representative geartrain 43 for rotatably connecting the two crankshafts 30 and 32 of the dual-crankshaft, opposed-piston engine 8 of FIG. 1, and is properly labeled “Prior Art”. The geartrain 43 is representative of a mechanical coupling device configured to rotatably connect the crankshafts so as to synchronize their rotations and deliver engine power to a power take off shaft. In some cases such a rotatable connection is referred to as a “positive coupling” or a “positive connection”. The crankshafts 30 and 32 are disposed in parallel, in a spaced-apart arrangement, but, because of the mechanical coupling device, they cannot rotate independently of each other. The geartrain 43 may comprise a system of gears that run between, and rotatably connect, corresponding ends of the crankshafts 30 and 32. For example, the geartrain 43 may comprise gears 44 fixed to respective ends of the crankshafts 30 and 32 for rotation therewith, and a gear 45 fixed to the end of a power take-off shaft 46. The geartrain 43 may further comprise idler gear assemblies 47, each mounted for rotation on a fixed shaft or post which may be cast with a cylinder block.

A geartrain is, in most cases, the preferred means for rotatably connecting the crankshafts. However, the opposed-piston environment poses particular challenges. Loads experienced by the geartrain of an opposed-piston engine are much higher than for a conventional valvetrain drive. Torsional vibration amplitudes are high, and torque reversals from each crankshaft are experienced. It is often the case that the geartrain is designed to impose a phase difference in rotations of the crankshafts (rotational phase difference). For example, the exhaust crankshaft may lead the intake crankshaft in phase in order to produce a desired uniflow scavenging effect. The phase lead causes a power split between the crankshafts as well as a phase difference between intake and exhaust crankshaft torques. Torsional resonance in the geartrain can result in loss of control over combustion volume.

Manifestly, elimination of a geartrain could benefit the dual-crankshaft, opposed-piston engine by reducing mass, size, friction, noise, and vibration. However elimination of mechanical coupling between the crankshafts poses two challenges. First, it is the case that a mechanical device coupling the crankshafts includes a means with which to provide an output for the power produced by the engine. Second, it is also the case that a mechanical coupling device synchronizes the rotations of the crankshafts for the purpose of establishing and maintaining a phase relationship therebetween. Further benefits may be realized by controlling the opposing movements of the pistons, each of which is coupled to a respective one of the two crankshafts.

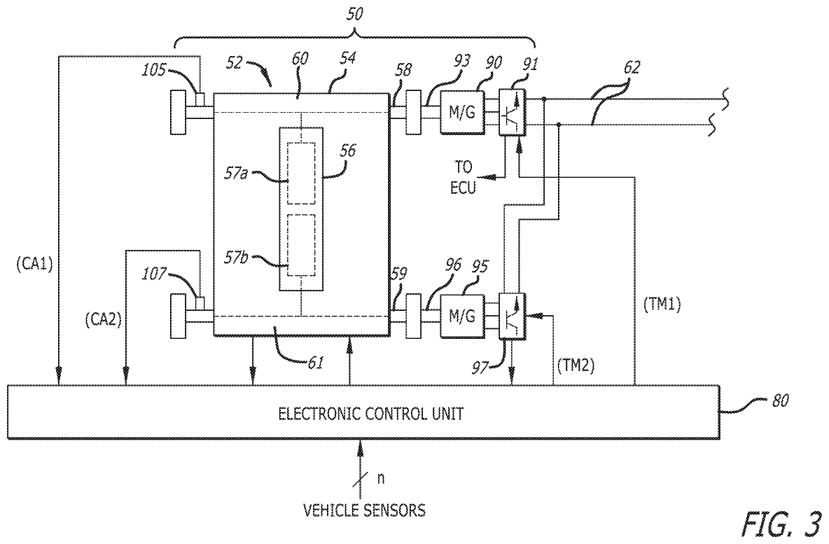

Dual-crankshaft, opposed-piston, engine device. FIG. 3 illustrates a dual-crankshaft, opposed-piston engine device according to the invention. The dual-crankshaft, opposed-piston engine device 50 includes an opposed-piston engine 52 constructed and operated in the manner illustrated in FIG. 1, with one exception: the opposed-piston engine does not include a mechanical device to rotatably connect the crankshafts. The opposed-piston engine 52 comprises an engine block 54 with at least one cylinder 56 in the bore of which two pistons 57a and 57b are disposed for opposed sliding motion. For example, the opposed-piston engine 52 may comprise one, two, or three or more cylinders. In any event, the cylinder 56 represents both single cylinder and multi-cylinder configurations of the opposed-piston engine 52. The cylinder 56 is disposed between two spaced-apart crankshafts 58 and 59 which are arranged in parallel and adapted in the manner of FIG. 1 to be rotated by the pistons 57a and 57b, respectively. The two crankshafts 58 and 59 are mounted for rotation in respective crankcase portions 60 and 61 of the engine block 54, but, unlike the engine 8 of FIG. 1, are not rotatably connected by a mechanical coupling device or system. In this regard, the crankshafts are said to be mechanically uncoupled and thus are free to rotate separately and independently of each other. In place of a geartrain, chain, belt, or other equivalent device to positively connect the crankshafts 58 and 59, the opposed-piston engine 52 is provided with an electronically-controlled system that provides a power output and controls the rotations of the crankshafts.

With further reference to FIG. 3, a motor/generator (MG) device 90 is provided for the crankshaft 58. The motor/generator device 90 is capable of supplying power to, and receiving power from, an electrical bus line 62 via an inverter 91. A rotating motor shaft 93 of the motor/generator device 90 may be directly coupled to the crankshaft 58 in such a manner as to enable the motor/generator device 90 to receive torque from, or supply torque to, the crankshaft 58. A motor/generator (M/G) device 95 is provided for the crankshaft 59. The motor/generator device 95 is capable of supplying power to, and receiving power from, the electrical bus line 62 via an inverter 97. A rotating motor shaft 96 of an AC of the motor/generator device 95 may be directly coupled to the crankshaft 59 in such a manner as to receive torque from, or supply torque to, the crankshaft 59.

The dual-crankshaft, opposed-piston engine device 50 further includes a control mechanization, which is a computer-based system comprising a programmed controller, a plurality of sensors, a number of actuators, and other machine devices. The control mechanization governs operations of various components of the dual-crankshaft, opposed-piston device. As per FIG. 3, control of the dual-crankshaft, opposed-piston engine device 50 is implemented by a control mechanization that includes a programmed, electronic engine control unit (ECU) 80. The ECU 80 may be constituted with one or more microprocessors, memory, I/O portions, converters, drivers, and so on, and is programmed to execute control algorithms during various engine operating conditions. Such algorithms may be embodied in control modules that are part of a system control program executed by the ECU 80 to regulate operations of the dual-crankshaft, opposed-piston engine device.

In addition to the ECU 80, the control mechanization may also comprise various sensors (physical and/or virtual). These may include engine sensors (engine operating state, engine speed, engine systems, etc.) and motor sensors (motor speed, generator current, etc.). Further, the control mechanization may comprise various actuators such as are found in the fuel, air handling, and cooling systems of an opposed-piston engine. The control mechanization may further comprise various actuators for motors, generators, and other electrical devices (converters, inverters, and so on).

As per FIG. 3, the control mechanization may comprise a rotation sensor for each crankshaft 58, 59 that is operative to detect a rotational condition of the crankshaft and to generate a signal indicating the detected rotational condition. In this regard, each such rotation sensor may comprise an angular position encoder which outputs information including a rotational position of the crankshaft. Relatedly, the rotational position of the crankshaft refers to an angular distance which the crankshaft has rotated in a clockwise (or a counterclockwise) direction from a predetermined position. Typically, such data is presented in degrees of rotation in a range of 0°-360°; an accuracy of, for example, at least ½ to ¼ of a degree is desirable.

Thus, the first crankshaft 58 may be equipped with a first angular position encoder, such as the angular position encoder 105, and the second crankshaft 59, may be equipped with a second angular position encoder, such as the angular position encoder 107. Each crankshaft may be further outfitted with other sensors, such as torsional vibration sensors. The ECU 80 may be connected to receive signals indicative of crankshaft rotational data such as crankshaft angle (CA1, CA2) from the angular position encoders 105 and 107 with which the ECU 80 may calculate a rotational position, speed, and acceleration of each crankshaft. Using these and possibly other parameters, the ECU 80 may perform a calculation to determine whether to supply torque to, or remove torque from, each crankshaft, and how much, in order to control keep the crankshafts at an appropriate angular velocity (RPM) during a desired operating condition. In addition, the ECU 80 may use crankshaft position data from the angular position encoders 105 and 107 and perform a calculation to determine whether to supply torque to, or remove torque from, either or both of the crankshafts, and how much, in order to position either or both of the opposing pistons in a cylinder of the dual-crankshaft, opposed-piston engine, the function of such positioning being to adjust an engine performance factor such as compression ratio. For these purposes, the ECU 80 may be connected to transmit signals (TM1, TM2) to the inverters 91 and 97 which cause either or both of the motor/generator devices 90 and 95 to supply torque to, or absorb torque from, either or both of the crankshafts 58, 59.

The dual-crankshaft, opposed-piston engine 52 is an internal combustion type engine which generates power by burning gasoline, diesel fuel, JP-8, Jet-A, or gaseous fuel, or any combination thereof, preferably by compression ignition, in response to regulation of fuel and air by the ECU 80. For example, the engine may operate by gasoline compression ignition (GCI). The motor/generator device 90 (designated as the first motor/generator device) is a power transducer capable of being operated as either an electric motor or a generator. In this regard, the motor/generator device 90, when operated as a motor, provides output torque to the crankshaft 58 through its motor shaft 93, in response to electrical energy input to the inverter 91 from the electrical bus lines 62. The motor/generator device 90 operates as a generator when driven by the crankshaft 58 via its motor shaft 93. The electrical power generated thereby is provided to the electrical bus lines 62 via the inverter 91. The motor/generator device 95 (designated as the second motor/generator device) is a power transducer capable of being operated as either an electric motor or a generator. In this regard, the motor/generator device 95, when operated as a motor, provides output torque to the crankshaft 59 through its motor shaft 96, in response to electrical energy input to the inverter 97 from the electrical bus lines 62. The motor/generator device 95 operates as a generator when driven by the crankshaft 59 via its motor shaft 96; electrical power generated thereby is provided to the electrical bus lines 62 via the inverter 97.

The inverters 91 and 97 are connected to the electrical bus lines 62 and are constructed so as to enable each of the motor/generator devices 90 and 95 to provide power directly to, and receive power from, other devices that may also be connected to the electrical bus lines 62. The function of each motor/generator device is regulated by way of its associated inverter. Thus, the inverter 91 controls an amount of AC power provided by, or provided to, the first motor/generator device 90 according to a magnitude and a polarity of a first Torque Command (TM1) issued by the ECU 80, and the inverter 97 controls an amount of AC power provided by, or provided to, the second motor/generator device 95 according to a magnitude and a polarity of a second Torque Command (TM2) issued by the ECU 80.

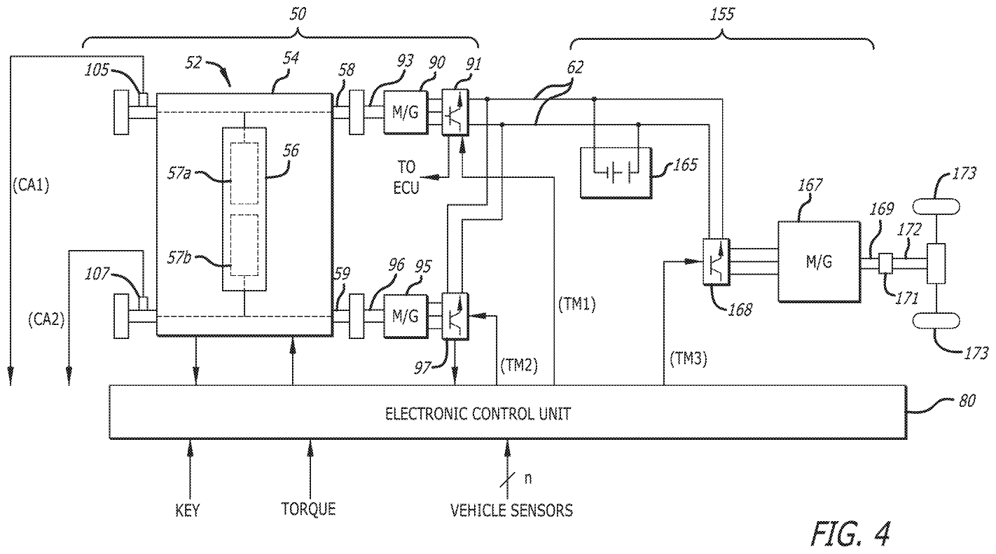

Hybrid Application. An exemplary application of the dual-crankshaft, opposed-piston engine device 50 in a hybrid drive system is illustrated in FIG. 4, wherein the dual-crankshaft, opposed-piston engine device 50 provides power to a hybrid powertrain system 155 of the electrical type, which may be configured to drive a hybrid vehicle. In this application, the first and second motor/generator devices 90 and 95 are coupled for delivery of electrical power to the hybrid powertrain system 155 by electrical bus lines 62. The hybrid powertrain system 155 may comprise a storage battery device 165 and at least one electrical motor device, in this case an electrical motor/generator device 167. The electrical motor/generator device 167 has an associated rotating motor shaft 169 that may be coupled to provide mechanical torque and rotation to one or more wheels of a hybrid vehicle by way of one or more of a driveshaft, an axle, and a hub flange. For example, the electrical motor/generator device 167 may be coupled through a transmission assembly 171 to a driveshaft 172 for provision to one or more wheels 173 of a hybrid vehicle. Alternatively, the hybrid powertrain system 155 may comprise one or more electrical motor/generator devices to drive each of a plurality of wheels of a multi-wheeled hybrid vehicle via a hub flange at each wheel.

The hybrid drive system may be controlled in the manner of a series hybrid (or a range extender) by the ECU 80, which may regulate the switching of each of the motor/generator devices 167, 90, and 95 between operation as a motor and as a generator via respective Torque Commands (TM). In a first mode of hybrid drive system operation, with the opposed-piston, internal combustion engine off, the motor/generator device 167 may be operated in the motor mode, with power supplied by the battery device 165. In instances in which the hybrid drive system powers a hybrid vehicle, when the motor/generator device 167, powered by the battery device 165, operates in motor mode, its output would be coupled to drive one or more wheels 173. If the hybrid vehicle is equipped with a regenerative braking system, the motor/generator device 167 may be operated in the generator mode to charge the battery device 165. In a second mode of hybrid drive system operation, with the opposed-piston engine 52 operating, the motor/generator device 167 may be operated in the motor mode, with power supplied by the battery device 165, while the motor/generator device 90 and/or the motor/generator device 95, operated in the generator mode, maintains, replenishes, or slows depletion of the charge of the battery device 165. In a third mode of hybrid drive system operation, with the opposed-piston engine 52 operating, the motor/generator device 167 may be operated in the motor mode, with power supplied by the battery device 165 and either or both of the motor/generator devices 90, 95. In cases where operation of the opposed-piston engine 52 is to be initiated, either the motor/generator device 90 or the motor/generator device 95 may be operated in the motor mode to crank the opposed-piston engine 52.

Crankshaft control. When a motor/generator device 90, 95 of the engine device 50 is operated as a motor by the ECU 80, the rotational torque produced by the motor is transmitted to the crankshaft to which the motor/generator device is connected. As the crankshaft rotates, the rotational torque transmitted to the crankshaft adds to, or subtracts from, the torque produced by the rotation of the crankshaft in response to movement of the pistons, thus advancing or retarding (modulating) rotation of the crankshaft. Advantageously, such modulation may be used to damp spikes, torque reversals, and torsional vibration in each crankshaft, thereby enhancing control over combustion volume. Other advantages related to control of piston location may also be realized.

The dual-crankshaft, opposed-piston device of the invention is constructed to monitor the rotation of each of the crankshafts 58, 59 for the purpose of maintaining smooth operation and synchronization of the crankshafts. In this regard, the ECU 80 may receive signals from one or more sensors associated with each crankshaft with which to detect vibrations, surges, drifts, and other anomalies in crankshaft rotation. When the ECU 80 detects an anomaly in the motion of a crankshaft, based on these sensor signals, the ECU 80 issues a torque command (TM1 or TM2) that causes the motor/generator device 90 or 95 to deliver torque as needed to counteract the detected anomaly in the affected crankshaft. In addition, the ECU 80 continuously detects a phase difference between the crankshafts based on the crankshaft angle signals (CA1, CA2) from the angular position encoders 105 and 107, and compares the calculated phase difference with a desired phase difference, correcting for any deviation from the desired phase difference by provision of angular position feedback to both crankshafts by way of Torque Commands.

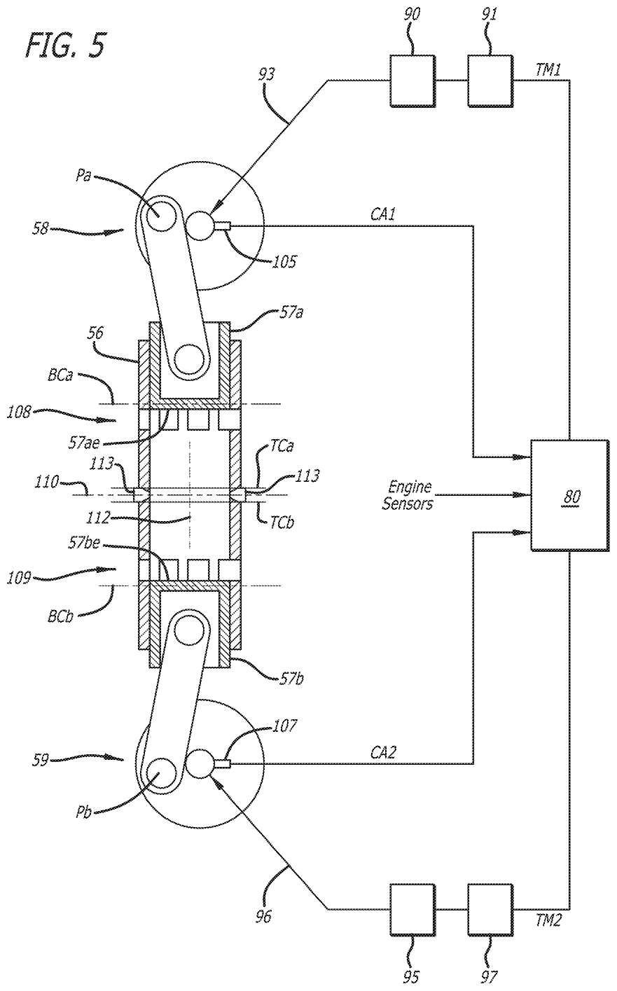

With respect to FIG. 5, each piston 57a, 57b has an unchanging relationship with a crank pin Pa, Pb with which it is coupled to its related crankshaft 58, 59. Thus, the location (or, position) of a piston with respect to the cylinder 56 in which it moves at any moment of operation of the engine 52 corresponds precisely with the degree of rotation of the crankshaft with which it is coupled, and control of the piston's location in the cylinder is afforded directly by control of the crankshaft's rotation. Advancing, or retarding, a crankshaft's rotation by application of rotational torque produced by the motor/generator device attached to it, causes a corresponding change in movement, and thus location, of the piston attached to it. When a motor/generator device of the engine device 50 is operated as a motor by the ECU 80, the rotational torque transmitted to the crankshaft to which the motor/generator device is coupled constitutes angular position feedback to the crankshaft with which the ECU 80 may modulate its rotation and thereby control the movement and/or location of the piston connected to it. This relationship may be used to advantage in that some factor related to performance of the opposed-piston engine may be advantageously changed, adjusted, or optimized, while the engine operates, by governing the rotation of a crankshaft to thereby control the position or location of a piston connected to the crankshaft. For example, control of the rotation of a crankshaft in order to control piston movement (location, speed, acceleration) in response to operating conditions of the opposed-piston engine may enable control of various engine performance factors such as compression ratio, scavenging rate, and so on.

Referring to FIG. 5, the ECU 80 may detect a respective rotational location for each crankshaft 58, 59, using the crankshaft angle signals (CA1, CA2) from the angular position encoders 105 and 107. Each crank angle signal indicates a location of a respective piston 57a, 57b as the engine operates. The location of a piston in the cylinder 56 may be understood with respect to an injector plane 110 situated in an intermediate portion of the cylinder and usually oriented to be perpendicular to the longitudinal axis 112 of the cylinder. The injector plane 110 is used as a reference landmark for injection of fuel by the fuel injectors 113. A piston's location may correspond to a distance between the injector plane and a selected feature of the piston (top ring edge, wristpin axis, and so forth). For example, a piston's location may be taken as a distance between the end surface of the piston and the injector plane 110. In this regard, as per FIG. 5 the location of the intake piston 57a may be determined as a distance in millimeters (MM) between the end surface 57ae and the injector plane 110.

In addition to the cylinder 56, pistons 57a and 57b, and crankshafts 58 and 59 of the engine 52, FIG. 5 shows intake and exhausts ports 108 and 109, respectively. For the following examples and embodiments, the crankshaft 58 and the piston 57a are also referred to as the “intake crankshaft 58” and the “intake piston 57a”, while the crankshaft 59 and the piston 57b are also referred to as the “exhaust crankshaft 59” and the “exhaust piston 57b”. During operation of the engine, the two pistons 57a and 57b move coaxially in the bore of the cylinder 56, toward each other in a compression stroke and away from each other in a power (or, expansion) stroke, repeating this sequence once each cycle of engine operation.

Variable Compression Ratio. A maximum volume is defined as cylinder volume contained between the piston end surfaces 57ae and 57be as the pistons move (simultaneously or sequentially) from BC, and a minimum volume is defined as cylinder volume contained between the end surfaces 57ae and 57be when the pistons are closest together. A compression ratio may be based on the maximum and minimum volumes. A swept compression ratio is based on a maximum volume defined in the cylinder, at the beginning of a compression stroke, between the piston end surfaces 57ae and 57be when the pistons 57a and 57b are farthest apart, at which time the intake port 108 and exhaust port 109 are open. Alternatively, a trapped compression ratio is based on a maximum volume defined between the piston end surfaces 57ae and 57be just as the intake and exhaust ports 108, 109 are completely closed early in a compression stroke. In some instances, the intake and exhaust ports 108, 109 may be completely closed simultaneously; in other instances, one port may be completely closed before the other port, in which case maximum volume occurs just as the last port is closed. In any case, the compression ratio is given as the maximum volume divided by the minimum volume.

It is desirable to be able to vary the compression ratio in response to changing engine loads in order to maximize fuel efficiency and rated power, and to support good combustion. This capability may be achieved in a dual-crankshaft, opposed-piston engine by changing the minimum volume defined between the piston end surfaces. To do so requires an ability to control the motion of at least one piston during engine operation so as to change the minimum distance between the piston end surfaces when the pistons are closest together. This may be accomplished in a dual-crankshaft, opposed-piston engine with a geartrain per FIG. 2 by addition of a device that acts between one crankshaft and the geartrain. This capability is gained at the expense of additional weight, size, cost, and friction.

However, in a dual-crankshaft, opposed-piston engine device according to the invention, minimum volume may be varied by provision of feedback control of at least one crankshaft, implemented by the ECU 80 acting through one of the motor/generator devices. For example, in response to a demanded or anticipated change in engine load, the ECU 80 may set a torque command (TM1, TM2) for a motor to vary the rotation speed of the crankshaft to which it is connected. The change in rotation speed may be calculated by the ECU 80 to be sufficient to change the time at which the piston coupled to the crankshaft passes through its TC location. Effectively, the calculated change alters the phase between the two crankshafts, with the feedback control calculated to change (increase or decrease) the rotation phase difference between the two crankshafts in such a direction and to such a degree as to result in a minimum distance between the pistons 57a and 57b that achieves a target minimum volume. The rotation phase difference, and thus the target minimum volume and the resulting compression ratio, may be maintained until another change in engine load indicating a change in compression ratio occurs.

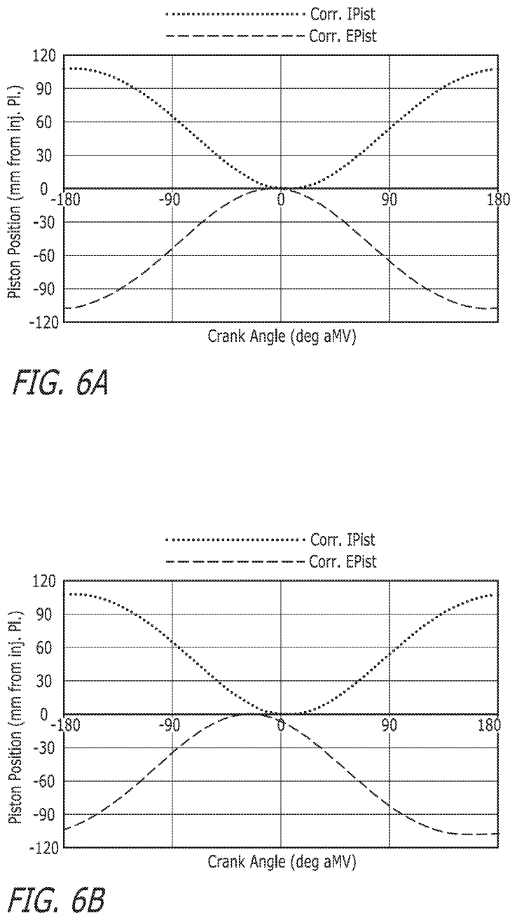

A change in rotation phase difference between the crankshafts 58 and 59, which causes a change in the minimum volume, and thus the compression ratio, is illustrated in FIGS. 6A and 6B. Presume that there is a 0 phase difference between the rotation of the intake and exhaust crankshafts, as shown in FIG. 6A. In this case the intake piston (IPist) 57a and the exhaust piston (EPist) 57b reach their TC locations simultaneously, at 0° CA of each crankshaft. A limited burst of positive torque added, for example, to the exhaust crankshaft 59 will cause it to advance in phase relative to the intake crankshaft 58 (or, vice versa). The advance in phase of the exhaust crankshaft causes an advance of in the location of the exhaust piston 57b. The result is illustrated in FIG. 6B, where the exhaust piston is shown reaching its TC location (0° CA of the exhaust crankshaft) approximately 8° before the intake piston 57a reaches its TC location (0° CA of the intake crankshaft). As a result, the minimum distance between the end surfaces of the pistons increases, as does the minimum volume. The result is a change in compression ratio; in this case the compression ratio is lowered as would be indicated for an increase in engine load.

An algorithm may be executed by the ECU 80 to vary the rotation phase difference between the first and second crankshafts in order to vary compression ratio. With reference to FIG. 5, as the engine operates, the ECU 80 calculates, estimates, or otherwise determines a current rotation phase difference between the crankshafts 58 and 59, based on the crank angle signals CA1 and CA2. If an engine load change has been requested, for example in the form of a torque demand, the ECU 80 calculates, estimates, or otherwise determines a target compression ratio value, determines a difference between the current and target rotation phase differences, and issues torque commands TM1 and TM2 that cause the first and second motor/generator devices 90 and 95 to change the rotation phase difference between the first and second crankshafts 58 and 59. Changing the rotation phase difference changes the location of at least one of the pistons as necessary to achieve the target compression ratio. Once the rotation phase difference reaches the reaches the target value, the rotation phase difference may be maintained until another change in compression ratio is indicated. Crank phasing may also be varied during a cycle of operation. For example, it may be desirable to provide zero crank phasing at minimum volume, followed by an exhaust crank lead for blow-down.

Variable scavenging. It is desirable to be able to tailor the state and composition of in-cylinder gas for various purposes while the engine operates. For example, response to a “toe-in” torque demand as when the accelerator pedal of a vehicle is depressed in order to accelerate, may require mostly fresh air in the cylinder to fully combust an increased quantity of fuel. Or, when the engine is being started under cold conditions, it may be desirable to retain hot gas in the cylinder. In dual-crankshaft, opposed-piston engines, means external to the cylinder provide a limited degree of control for variable scavenging. These include intake channel components that govern supercharger, compressor, and EGR operations, and exhaust channel components that govern turbine operations and channel gas flow. Within the cylinder, important factors affecting scavenging include exhaust port height, intake port location, and rotational phase difference between the pistons. The exhaust port frequently is configured with greater height than the intake port which, when combined with a rotational phase lead for the exhaust crankshaft, provides a larger effective open area than the intake port, thereby aiding blowdown and scavenging. However, these parameters are fixed for conventionally-configured dual-crankshaft, opposed-piston engines.

With reference to FIG. 5, intake and exhaust ports are formed in respective end portions of the cylinder 56. The intake port 108 is provided in the vicinity of a first end of the cylinder 56 and the exhaust port 109 is provided in the vicinity of a second end of the cylinder 56. The intake piston 57a, slides back and forth past the intake port 108, while the exhaust piston 57b, slides back and forth past the exhaust port 109. The BC location of the intake piston 57a (BCa) is between the intake port 108 and the first end of the cylinder and the BC location of the exhaust piston 57b (BCb) is between the exhaust port 109 and the second end of the cylinder. The intake port 108 is opened and closed by the intake piston 57a. In this regard the intake port 108 is opened as the end surface 57ae of the intake piston 57a slides past it when approaching its BC location. The intake port 108 closes as the end surface 57ae (or an edge of an upper piston ring) slides past it when the intake piston 57ae moves away from its BC location. The exhaust port 109 is opened and closed by the exhaust piston 57b in a similar manner. Relative timing and area of intake port and exhaust port openings and closings control the replacement of exhaust gas exiting the cylinder 56 through the exhaust port 109 by charge air entering the cylinder 56 through the intake port 108 during the process of scavenging.

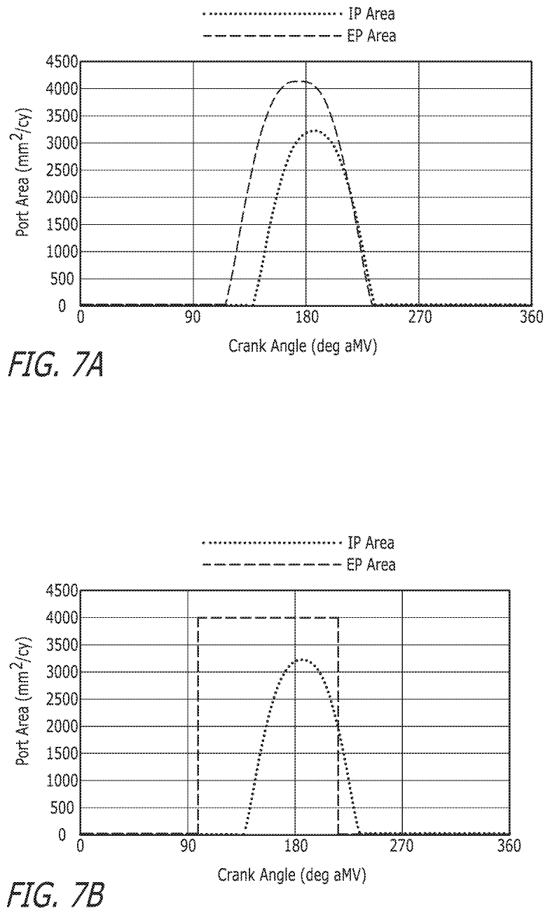

In a dual-crankshaft, opposed-piston engine device according to the invention, control of exhaust piston motion and location when the intake and exhaust ports are open may add a desirable degree of variable in-cylinder scavenging control. Since control of piston location is afforded via independent control of the crankshafts 58 and 59 by the motor/generator devices 90 and 95, either piston 57a, 57b may be accelerated, decelerated, or held in position based on signals TM1, TM2 provided to the inverters 91 and 97 by the ECU 80. Preferably, for variable scavenging, such control is exercised as a piston moves to and through its BC location. For example, variable scavenging may be enabled by control of the exhaust piston 57b. The effective open area of the exhaust port 109 may be dynamically changed by provision of feedback control of at least the exhaust crankshaft 59, based on the signal TM2 provided by the ECU 80 to the motor/generator device 95. FIGS. 7A and 7B show a degree of scavenging variability representative of that which may be obtained with independent control of the intake and exhaust crankshafts according to the invention. Each figure shows two plots, each representing a total open port area as the piston associated with the port slides toward and away from its BDC location, opening and then closing the port. Each IP Area plot represents the amount of open port area per CA of rotation of the intake crankshaft. Each EP Area plot represents the amount of open port area per CA of rotation of the exhaust crankshaft. FIG. 7A illustrates scavenging as may be provided with a cylinder configured with a fixed height difference between the exhaust and intake ports and a geartrain-imposed crankshaft phase difference, with the exhaust crankshaft leading the intake crankshaft in phase. FIG. 7B illustrates an extreme example of scavenging in which the ECU 80 commands accelerated changes in location of the exhaust piston 57b, as represented by the rising and falling edges of the exhaust port area plot, between which the ECU 80 commands retention of the exhaust piston 57b at or near BCb.

An algorithm may be executed by the ECU 80 to vary the location of the exhaust piston 57b in order to vary scavenging. With reference to FIG. 5, as the engine operates, the ECU 80 calculates, estimates, or otherwise determines a current scavenging rate when the intake and exhaust ports 108, 109 are open. If a current engine operating condition indicates a desired scavenging rate, the ECU 80 calculates, estimates, or otherwise determines a difference between the current and desired scavenge rates, and issues torque commands TM1 and TM2 that maintain, accelerate, decelerate, and/or freeze the motions of the intake and exhaust pistons 57a and 57b as necessary to achieve target locations needed to generate the desired scavenging rate.

A novel approach to crankshaft control of dual-crankshaft, opposed-piston engines has been described. This approach dispenses with heavy, noisy, inefficient, and expensive mechanical coupling devices used to rotatably connect the crankshafts. Although the invention has been described using electrical motor/generators to enable feedback control of the crankshafts, the concept should be equally applicable to hydraulic motors, and it should be understood that various other modifications can be made without departing from the spirit of the described principles. Accordingly, other embodiments are within the scope of the following claims.

1. An opposed-piston engine device, comprising:
an opposed-piston engine comprising a first crankshaft and a second crankshaft, configured to rotate independently of each other;
a first power transducer operatively coupled to the first crankshaft;
a second power transducer operatively coupled to the second crankshaft; and,
a control mechanization configured to determine a rotation phase difference between the first and second crankshafts and to cause the first and second power transducers to change the rotation phase difference between the first and second crankshafts.

2. The opposed-piston engine device of claim 1 in which the control mechanization comprises:
a first rotation sensor engaging the first crankshaft;
a second rotation sensor engaging the second crankshaft; and,
a control unit which is:
connected to receive signals from the first and second rotational sensors and configured to determine the rotation phase difference based on the signals received from the first and second rotational sensors; and,
connected to transmit signals to the first and second power transducer devices which cause the first and second power transducers to change the rotation phase difference.

3. The opposed-piston engine device of claim 2 in which the first and second power transducers each comprises an electric motor/generator device.

4. The opposed-piston engine device of claim 2 in which the change of the rotation phase difference changes a compression ratio of the opposed-piston engine.

5. The opposed-piston engine device of claim 2 in which the change of the rotation phase difference changes a scavenging rate of the opposed-piston engine.

6. The opposed piston engine device of claim 2 in which the first and second rotation sensors each comprises an angular position encoder having an accuracy of at least ½ to ¼ of a degree.

7. The opposed-piston engine of claim 1 in which the opposed-piston engine further comprises a cylinder, and first and second pistons disposed for opposing sliding movement in the cylinder, the first piston being coupled to the first crankshaft and the second piston being coupled to the second crankshaft, in which the change of the rotation phase difference between the first and second crankshafts causes a change in location of at least one of the first and second pistons.

8. The opposed-piston engine device of claim 7 in which the first and second power transducers each comprises an electric motor/generator device.

9. The opposed-piston engine device of claim 8 in which the change of the location of at least one of the first and second pistons changes a compression ratio of the opposed-piston engine.

10. The opposed-piston engine device of claim 9 in which the change of the location of at least one of the first and second pistons occurs when the at least one of the first and second pistons is near a top center location in the cylinder.

11. The opposed-piston engine device of claim 8 in which the change of the location of at least one of the first and second pistons changes a scavenge rate of the opposed-piston engine.

12. The opposed-piston engine device of claim 11 in which the change of the location of at least one of the first and second pistons occurs when the at least one of the first and second pistons is near a bottom center location in the cylinder

13. An opposed-piston engine device, comprising:
an opposed-piston engine comprising at least one cylinder and a pair of pistons disposed for opposed sliding movement in a bore of the cylinder;
a first crankshaft coupled to a first piston of the pair of pistons;
a second crankshaft coupled to a second piston of the pair of pistons;
the first and second crankshafts being mechanically uncoupled from each other;
a first electrical transducer device operatively coupled to the first crankshaft;
a second electrical transducer operatively coupled to the second crankshaft;
a first angular position encoder configured to sense a rotational position of the first crankshaft;
a second angular position encoder configured to sense a rotational position of the second crankshaft; and,
a control unit connected to receive signals from the first and second angular position encoders and configured to determine a rotation phase difference between the first crankshaft and the second crankshaft based on the signals received from the first and second angular position encoders; and,
the control unit connected to transmit signals to the first and second electrical transducer devices which cause the first electrical transducer device and/or the second electrical transducer device to change the rotation phase difference between the first crankshaft and the second crankshaft.

14. The opposed-piston engine device of claim 13, in which the first electrical transducer device comprises a first electric motor/generator device and the second electrical transducer device comprises a second electric motor/generator device.

15. The opposed-piston engine device of claim 14, in which the change of the rotation phase difference between the first crankshaft and the second crankshaft changes a compression ratio of the opposed-piston engine.

16. The opposed-piston engine device of claim 14, in which the change of the rotation phase difference between the first crankshaft and the second crankshaft changes a scavenge ratio of the opposed-piston engine.

17. The opposed-piston engine device of claim 15, in which the first and second rotation sensors each comprises an angular position encoder having an accuracy of at least ½ to ¼ of a degree.

18. The opposed-piston engine device of claim 16, in which the first and second rotation sensors each comprises an angular position encoder having an accuracy of at least ½ to ¼ of a degree.

19. An opposed-piston engine device, comprising:
an opposed-piston engine comprising at least one cylinder and a pair of pistons disposed for opposed sliding movement in a bore of the cylinder;
a first crankshaft coupled to a first piston of the pair of pistons;
a second crankshaft coupled to a second piston of the pair of pistons;
the first and second crankshafts being mechanically uncoupled so as to rotate independently of each other;
a first electrical transducer device operatively coupled to the first crankshaft;
a second electrical transducer operatively coupled to the second crankshaft;
a first rotation sensor configured to detect a rotational position of the first crankshaft;
a second rotation sensor configured to detect a rotational position of the second crankshaft; and,
a control unit connected to receive signals from the first and second rotation sensors and configured to determine a location of the first piston with respect to the second piston based on the signals received from the first and second rotation sensors;
the control unit connected to transmit signals to the first and second electrical transducer devices which cause the first electrical transducer device and/or the second electrical transducer device to change the location of the first piston with respect to the second piston by rotational feedback to at least one of the first crankshaft and the second crankshaft.

20. The opposed piston engine device of claim 19 in which the first and second rotation sensors each comprises an angular position encoder having an accuracy of at least ½ to ¼ of a degree.

21. The opposed-piston engine device of claim 19 in which the first and second power transducers each comprises an electric motor/generator device.

22. The opposed-piston engine device of claim 19 in which changing the location of the first piston with respect to the second piston changes a compression ratio of the opposed-piston engine.

23. The opposed-piston engine device of claim 22 in which changing the location of the first piston with respect to the second piston changes the compression ratio during a single cycle of engine operation.

24. The opposed-piston engine device of claim 19 in which changing the location of the first piston with respect to the second piston changes a scavenge efficiency of the opposed-piston engine.

25. A system for controlling a position of a first piston relative to a position of a second piston moving in opposition to the first piston in a cylinder of an opposed-piston engine, comprising:
a first crankshaft coupled to the first piston;
a second crankshaft coupled to the second piston;
the first and second crankshafts adapted to rotate independently of each other;
a first electrical transducer device operatively coupled to the first crankshaft;
a second electrical transducer operatively coupled to the second crankshaft;
a first rotation sensor operatively engaging the first crankshaft;
a second rotation sensor operatively engaging the second crankshaft; and,
a control unit connected to receive signals from the first and second rotation sensors and configured to determine a rotational position of the first crankshaft with respect to the second crankshaft based on the signals received from the first and second rotation sensors;
the control unit connected to transmit signals to the first and second electrical transducer devices which cause the second electrical transducer device to change the position of the second crankshaft with respect to the first crankshaft.
